(19) United States
(12) Patent Application Publication
(10) Pub. No.: US 2026/0333297 A1
(43) Pub. Date: Oct. 22, 2026

(54) PAGING IN CLUSTERED SIGNALING PERIODS

(71) Applicant: Lenovo (United States) Inc., Morrisville, NC (US)

(72) Inventors: Karthikeyan Ganesan, Nauheim (DE); Ravi Kuchibhotla, Chicago, IL (US)

(73) Assignee: Lenovo (United States) Inc., Morrisville, NC (US)

(21) Appl. No.: 19/563,822

(22) Filed: Mar. 11, 2026

(51) Int. Cl. H04W 68/02

(52) U.S. Cl. CPC H04W 68/02

(57) ABSTRACT

Various aspects of the present disclosure relate to paging in clustered signaling periods. A user equipment (UE) may receive signaling from a network equipment (NE) that indicates a periodicity associated with a set of clustered signaling periods, that indicates a relationship between the periodicity and a paging cycle associated with at least one paging message, and that indicates a paging offset relative to a synchronization signal block (SSB) associated with at least one clustered signaling period of the set of clustered signaling periods. The UE may determine the at least one clustered signaling period based on the periodicity and the relationship between the periodicity and the paging cycle. The UE may receive the at least one paging message from the NE during at least one paging occasion within the at least one clustered signaling period based on the paging offset relative to the SSB.

### TECHNICAL FIELD

The present disclosure relates to wireless communications, and more specifically to time-frequency resource management for paging.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies, including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive signaling that indicates a periodicity associated with a set of clustered signaling periods, that indicates a relationship between the periodicity and a paging cycle associated with at least one paging message, and that indicates a paging offset relative to a synchronization signal block (SSB) associated with at least one clustered signaling period of the set of clustered signaling periods, determine, based on the periodicity and the relationship between the periodicity and the paging cycle, the at least one clustered signaling period, and receive, based on the paging offset relative to the SSB, the at least one paging message during at least one paging occasion (PO) within the at least one clustered signaling period.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, determine, based on the periodicity and the relationship between the periodicity and the paging cycle, the at least one clustered signaling period, and receive, based on the paging offset relative to the SSB, the at least one paging message during at least one PO within the at least one clustered signaling period.

A method performed or performable by a UE for wireless communication is described. The method may include receiving signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, determining, based on the periodicity and the relationship between the periodicity and the paging cycle, the at least one clustered signaling period, and receiving, based on the paging offset relative to the SSB, the at least one paging message during at least one PO within the at least one clustered signaling period.

In some implementations of the UE, the processor, and the method described herein, the UE, the processor, and the method may further be configured to, capable of, or operable to determine a current cluster index based on a system frame number (SFN) and the periodicity, and determine at least one cluster index associated with the at least one clustered signaling period based on the current cluster index and the relationship between the periodicity and the paging cycle. In some implementations, the UE, the processor, and the method may further be configured to, capable of, or operable to determine a current cluster index based on an SFN and the periodicity, and determine, based on a hash function and the relationship between the periodicity and the paging cycle, a hashed identifier associated with the UE, where the current cluster index is associated with the at least one clustered signaling period based on the current cluster index matching the hashed identifier. In some implementations, the UE, the processor, and the method may further be configured to, capable of, or operable to switch, during the at least one clustered signaling period, to an active state from an inactive state, determine the at least one PO within the at least one clustered signaling period, and monitor the at least one PO for the at least one paging message, where the at least one paging message is received based on the monitoring.

In some implementations, the UE, the processor, and the method may further be configured to, capable of, or operable to determine a paging start time based on a start of the SSB and the paging offset, where the paging start time corresponds to the at least one PO. In some implementations, the UE, the processor, and the method may further be configured to, capable of, or operable to apply a hash function to an identifier associated with the UE, where the hash function maps the identifier to at least one of a time domain index or a frequency domain index associated with the at least one PO. In some implementations, the relationship indicates that the paging cycle is one of equal to the periodicity, a multiple of the periodicity, or a fraction of the periodicity. In some implementations, the set of clustered signaling periods includes additional signaling that is common to a set of UEs including the UE, and the additional signaling includes at least one of synchronization signals, broadcast control channels, system information, or random access channels.

An NE (e.g., a base station) for wireless communication is described. The NE may be configured to, capable of, or operable to perform one or more operations as described herein. For example, the NE may be configured to, capable of, or operable to transmit signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, and transmit, based on the paging offset relative to the SSB, the at least one paging message during at least one PO within the at least one clustered signaling period of the set of clustered signaling periods.

A processor (e.g., a standalone processor chipset, or a component of an NE) for wireless communication is described. The processor may be configured to, capable of, or operable to perform one or more operations as described herein. For example, the processor may be configured to, capable of, or operable to transmit signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, and transmit, based on the paging offset relative to the SSB, the at least one paging message during at least one PO within the at least one clustered signaling period of the set of clustered signaling periods.

A method performed or performable by an NE (e.g., a base station) for wireless communication is described. The method may include transmitting signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, and transmitting, based on the paging offset relative to the SSB, the at least one paging message during at least one PO within the at least one clustered signaling period of the set of clustered signaling periods.

In some implementations of the NE, the processor, and the method described herein, the NE, the processor, and the method may further be configured to, capable of, or operable to determine a current cluster index based on an SFN and the periodicity, and determine at least one cluster index associated with the at least one clustered signaling period based on the current cluster index and the relationship between the periodicity and the paging cycle. In some implementations, the NE, the processor, and the method may further be configured to, capable of, or operable to determine a current cluster index based on an SFN and the periodicity, and determine, based on a hash function and the relationship between the periodicity and the paging cycle, respective hashed identifiers associated with a set of UEs, where the current cluster index is associated with the at least one clustered signaling period based on the current cluster index matching at least one hashed identifier of the respective hashed identifiers. In some implementations, the NE, the processor, and the method may further be configured to, capable of, or operable to switch, during the at least one clustered signaling period, to an active state from an inactive state. In some implementations, the relationship indicates that the paging cycle is one of equal to the periodicity, a multiple of the periodicity, or a fraction of the periodicity. In some implementations, the set of clustered signaling periods includes additional signaling that is common to a set of UEs, and the additional signaling includes at least one of synchronization signals, broadcast control channels, system information, or random access channels.

### BRIEF DESCRIPTION OF THE DRAWINGS

FIG. 1 illustrates an example of a wireless communications system in accordance with aspects of the present disclosure.

FIG. 2 illustrates an example of a transmission diagram, in accordance with aspects of the present disclosure.

FIG. 3 illustrates an example of a wireless communications system, in accordance with aspects of the present disclosure.

FIG. 4 illustrates an example of a resource diagram, in accordance with aspects of the present disclosure.

FIG. 5 illustrates an example of a signaling diagram, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. The NE may transmit and/or receive signaling periodically during clustered signaling periods, where each clustered signaling period includes a burst of signaling that is common to multiple UEs. For example, the signaling may include, but is not limited to, synchronization signals (e.g., SSBs), broadcast control channels, system information, paging channels, and/or random access channels. The NE and/or one or more UEs may transition from an inactive state to an active state during the clustered signaling periods to communicate (e.g., transmit and/or receive) the signaling, and may transition back to the inactive state after (e.g., in response to, based on) communicating the signaling to conserve power.

In some examples, the NE may transmit one or more paging messages to notify one or more UEs of incoming data or other events. The NE transmits the paging messages according to a paging cycle during time-frequency resources allocated for the paging messages, referred to as POs. In some cases, if paging is performed within the clustered signaling periods, then the allocation of POs relative to other signaling within the clustered signaling period may be unclear, potentially resulting in inefficient resource utilization or misalignment between the UE and the NE. For example, without a defined relationship between a paging cycle and the periodicity of the clustered signaling periods, and without a defined paging offset relative to other signaling in the clustered signaling periods (e.g., an SSB), the UE may be unable to accurately determine when to monitor for paging messages within the clustered signaling period, leading to missed paging messages or unnecessary power consumption from monitoring incorrect time periods.

As described herein, to improve efficiency of resource utilization and to enable accurate determination of POs within clustered signaling periods, an NE and a UE may implement a paging framework that defines a relationship between the paging cycle and the periodicity of the clustered signaling periods, as well as a paging offset relative to an SSB within the clustered signaling periods. For example, the NE may transmit signaling to a UE that indicates information for paging in clustered signaling periods. The information includes a periodicity defining a set of clustered signaling periods, a relationship between the periodicity and a paging cycle for at least one paging message, and a paging offset relative to an SSB within the clustered signaling periods. The UE may use the periodicity and the relationship between the periodicity and the paging cycle to determine at least one clustered signaling period during which to monitor for paging messages. For example, the UE may determine a current cluster index by applying an SFN and the periodicity, and determine at least one cluster index identifying the at least one clustered signaling period by applying the current cluster index and the relationship between the periodicity and the paging cycle. The UE may use the paging offset relative to the SSB to receive the at least one paging message during at least one PO within the at least one clustered signaling period. For example, the UE uses the paging offset to determine a paging start time by referencing a start of the SSB, providing for the UE to accurately identify when to monitor for paging messages within the clustered signaling period.

By performing the described techniques, a device (e.g., a UE and/or an NE) in a wireless communications system may provide for improved resource utilization, reduced power consumption, and enhanced paging reliability within clustered signaling periods. The paging framework enables the UE to determine the at least one clustered signaling period during which to monitor for paging messages using the relationship between the paging cycle and the periodicity of the clustered signaling periods. The UE may transition to an active state during the clustered signaling periods that include paging messages for the UE. For example, the UE may use the paging offset relative to the SSB to accurately identify the at least one PO within the at least one clustered signaling period, monitor the correct POs for the paging messages, and transition back to an inactive state after monitoring. The paging framework reduces power consumption at the UE by enabling the UE to remain in the inactive state during clustered signaling periods that do not include paging messages for the UE, while ensuring reliable reception of paging messages by providing a defined relationship between the paging cycle and the periodicity of the clustered signaling periods and a defined paging offset relative to the SSB.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

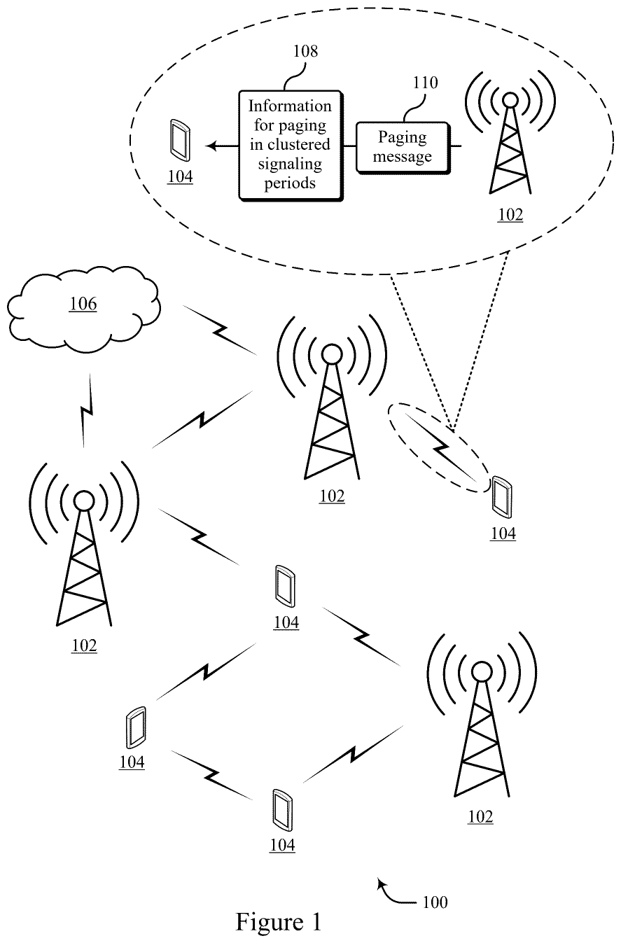

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology, including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be, or include, or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least two numerologies). For example, FR2 may be associated with a third numerology (e.g., μ=²), which includes 60 kHz subcarrier spacing; and a fourth numerology (e.g., μ=3), which includes 120 kHz subcarrier spacing.

In the wireless communications system 100, the NEs 102 and the UEs 104 may consume energy to perform various operations (e.g., wireless communications, signal processing, data transmission, data reception). In some cases, the NEs 102 and the UEs 104 may support energy saving techniques to reduce power consumption, such as discontinuous transmission (DTX), discontinuous reception (DRX), or sleep modes. For example, an NE 102 and/or a UE 104 may enter an inactive state (e.g., low-power state, sleep state, idle state) if there is no downlink transmission or uplink reception, and may transition to an active state (e.g., may wake up) if transmission or reception is to be performed. An inactive state may refer to a power state in which a device reduces or suspends operation of one or more components to conserve energy. During a transition from an active state to an inactive state, the device may deactivate or power down various components, such as power amplifiers, radio frequency chains, baseband processing units, or other circuitry that is not utilized in the inactive state. For DTX, a device (e.g., the NE 102 or the UE 104) refrains from transmitting signals during periods with no data to transmit, providing for the device to reduce power consumption by deactivating or reducing power to transmitter components during inactive periods. For DRX, the device monitors for incoming signals during configured active periods and enters an inactive state during configured inactive periods, providing for the device to reduce power consumption by deactivating or reducing power to receiver components if reception is not expected.

Data traffic in the wireless communications system 100 may increase over time, such as by approximately 6.4 gigabytes (GB) per user per month. Operators of the wireless communications system 100 may implement energy-saving techniques due to the increased data traffic, rising overhead of spectrum (e.g., the range of radio frequencies allocated for wireless communication), capital investment, and ongoing RAN maintenance and upgrades, among other factors. In some cases, 5G use cases and the adoption of millimeter wave (mm-Wave) frequencies, which operate in the frequency range of approximately 24 GHz to 100 GHz and enable high-bandwidth communication, utilize an increased numerical quantity of sites and antennas when compared with previous use cases (e.g., 4G, LTE). Additionally, or alternatively, as wireless communications systems (e.g., including the wireless communications system 100) implement 5G across industries and geographical areas, handling more advanced services and applications utilizing relatively high data rates (e.g., extended reality (XR) applications), networks become denser, use more antennas, larger bandwidths, and more frequency bands. The increased numerical quantity of sites and antennas, as well as the increased data rates, may lead to increased energy consumption and emissions. Thus, the wireless communications system 100 may implement network energy saving (e.g., energy saving at one or more NEs 102 or other network-related devices) to reduce environmental impact through decreased greenhouse gas emissions, as well as to achieve operational cost savings.

In some examples, the network energy savings techniques include configuring common channels within an active duration (e.g., time) of a cell. A cell may refer to a logical entity associated with an NE 102 that provides wireless communication services to one or more UEs 104 within a geographic coverage area. The cell may be associated with one or more defined (e.g., configured) radio resources, including time resources, frequency resources, and/or spatial resources (e.g., beams), that the NE 102 manages for communication with the UEs 104. If the NE 102 activates a network energy saving configuration for a cell, then common channels may be transmitted within an active time of the NE 102 to save power. For example, if an NE 102 activates the network energy saving configuration, such as an idle mode cell discontinuous transmission/discontinuous reception (DTX/DRX) configuration, then the common channels are to be transmitted within the active time of the NE 102 to save power. Otherwise, the NE 102 may consolidate or cluster the common channel frame to provide for the NE 102 to enter an inactive state as part of the network energy savings.

The common channels may include channels and/or signals that carry information accessible to multiple ULEs 104, such as an SSB, an SIB, a paging channel, and/or a physical RACH (PRACH). The SSB may include a primary synchronization signal (PSS), a secondary synchronization signal (SSS), and a physical broadcast channel (PBCH), which enable ULEs 104 to synchronize with the NE 102 and obtain initial system information. The SIB may include system information block type 1 (SIB1), which provides system information for initial access, as well as other SIB types that provide additional configuration information. The paging channel may include one or more POs, which are examples of defined time-frequency resources during which the NE 102 transmits paging messages to notify UEs 104 of incoming signaling (e.g., data and/or control information). The PRACH may include one or more random access occasions (ROs) during which UEs 104 transmit RACH preambles to initiate random access procedures. In some cases, the common channels may be clustered in the time domain to improve power efficiency at the NE 102 and/or the UE 104. Clustering refers to grouping transmissions of common channels into time periods, followed by inactive durations during which the NE 102 and/or the UE 104 may enter a low-power state.

A clustered signaling period refers to a defined time interval during which an NE 102 transmits the common channels and/or signals in a burst, followed by an inactive duration during which the NE 102 and/or one or more UEs 104 may enter a low-power state. A periodicity of the clustered signaling periods may define the time interval between consecutive clustered signaling periods. For example, the periodicity defines how frequently the NE 102 transmits the common channels and/or signals, and may be configured based on network energy saving criteria and UE performance considerations. A shorter periodicity (e.g., less than a threshold value, 20 ms) may provide lower latency for initial access and paging but may result in higher energy consumption at the NE 102. A longer periodicity (e.g., greater than a threshold value, 160 ms or greater) may enable greater energy savings at the NE 102 but may increase latency for UE operations, such as cell search and paging reception. The periodicity may be indicated to UEs 104 via system information, such as in SIB1 or other broadcast signaling, to enable the UEs 104 to determine when to transition to an active state for monitoring the clustered signaling period.

In some examples, the common channels and/or signals may include one or more SSBs that are transmitted together within a defined time window, referred to as an SSB burst. Each SSB in the SSB burst may be transmitted using a different beam direction to provide coverage across multiple spatial directions. The SSB burst enables UEs 104 to perform cell search and synchronization by detecting one or more SSBs within the burst, where each SSB maps to a beam index. In NR systems, an SSB burst has a duration of 5 ms, spanning a half frame, and may be transmitted in either the first half or the second half of a radio frame. The half frame in which the SSB burst is transmitted is indicated in a master information block (MIB), which is carried by a PBCH within the SSB. For a UE 104 performing initial access, the default SSB periodicity is 20 ms. The actual periodicity of SSBs, which may differ from the default periodicity, is indicated to the UE 104 via SIB1. The SSB periodicity may be configured to values, such as 5 ms, 10 ms, 20 ms, 40 ms, 80 ms, or 160 ms, depending on deployment scenarios and network configurations. The SSB provides time and frequency synchronization for UEs 104, as well as cell identification through the PSS and SSS.

The wireless communications system 100 may support various RATs, including 5G and 6G. The synchronization signal structures for 6G may account for a synchronization raster design, spectrum allocation, minimum supported radio frequency and baseband (BB) UE 104 bandwidth without spectrum aggregation, mobile broadband service criteria, energy efficiency for both base stations (e.g., NEs 102) and UEs 104, detection and tracking performance, latency and complexity (e.g., initial cell search), coverage targets, common design for diverse device types, supported deployment scenarios, and whether a single synchronization signal structure is sufficient for various use cases. Synchronization signal periodicities greater than a threshold value (e.g., 20 ms or longer) for network energy savings may impact UE 104 performance and user experience for initial access. For the network energy savings, the NE 102 may provide cell-common signaling (e.g., synchronization signals, broadcast physical downlink control channel (PDCCH), SIB1, other SIBs, paging, and physical random access channel (PRACH)) through clustered provisioning, where the NE 102 groups different cell-common signaling types together in time. Additionally, or alternatively, the NE 102 may provide the cell-common signaling through on-demand provisioning, where the NE 102 transmits cell-common signaling in response to UE 104 requests. The NE 102 may also provide UE-specific signaling for various load conditions through clustered provisioning with cell-common signaling or through un-clustered provisioning with cell-common signaling. The impact on the UE 104 may include cell search complexity and latency, including frequency search latency, power consumption of the UE 104, synchronization signal detection, coverage and tracking performance, radio resource management (RRM), mobility, and beam management. To improve the identified impacts, the UE 104 and/or the NE 102 may implement additional synchronization signals, adaptation of synchronization signal transmission periodicity, and/or sparser synchronization rasters. A synchronization raster refers to a set of candidate frequency positions at which a UE 104 may search for synchronization signals during initial cell search. A sparser synchronization raster includes fewer candidate frequency positions, which may reduce cell search latency and UE 104 power consumption.

The UE 104 may operate in different radio resource control (RRC) modes, including RRC connected mode, RRC idle mode, and/or RRC inactive state. In RRC connected mode, the UE 104 maintains an active connection with the NE 102 and may transmit and receive data. In RRC idle mode, the UE 104 does not have an active connection with the NE 102 and performs cell reselection and monitors for paging messages. In RRC inactive mode, the UE 104 maintains a context at the NE 102 but does not have an active data connection, enabling faster connection resumption compared to RRC idle mode, while still conserving power. The RRC modes differ from DTX and/or DRX cycles in that the RRC modes define an overall connection status and capabilities of the UE 104 with respect to the network, whereas DTX and DRX define power-saving mechanisms that may be applied within a given RRC state to reduce energy consumption during periods of inactivity. Paging enables the NE 102 to notify UEs 104 in an idle mode and/or inactive mode of incoming data, voice calls, system information updates, or other events that result in the UE 104 transitioning to a connected mode. In addition to synchronization signals, the common channels and/or signals may include one or more paging resources and/or messages clustered within the active duration of the NE 102.

The NE 102 transmits paging messages on a paging channel, which the UE 104 monitors according to a configured paging cycle. The paging cycle defines a periodicity at which the UE 104 wakes up from a low-power or inactive state (e.g., of a DRX cycle or other energy saving cycle different from the RRC modes) to monitor for paging messages. A shorter paging cycle may reduce latency for receiving paging messages but may increase power consumption at the UE 104 due to more frequent monitoring. A longer paging cycle may reduce power consumption at the UE 104 but may increase latency for receiving paging messages. The NE 102 may transmit paging messages during POs, which are time-frequency resources allocated for paging transmissions. The POs may be organized within paging frames (PFs), where a PF is one radio frame and may include one or more POs or a starting point of a PO. For example, the paging cycle may include one or more PFs, and each PF may include one or more POs at which the UE 104 monitors for paging messages. The UE 104 monitors the POs within the PFs according to the paging cycle to determine whether a paging message is addressed to the UE 104. If the UE 104 detects (e.g., receives) a paging message addressed to the UE 104, the UE 104 may initiate a connection establishment or connection resume procedure to receive the incoming data or respond to a paging event (e.g., receiving the paging message). The paging message may include a paging identifier, such as a 5G subscription temporary mobile identity (TMSI) (5G-S-TMSI), that the UE 104 uses to determine whether the paging message is intended for the UE 104. The NE 102 may transmit paging messages to multiple UEs 104 within the same PO by including multiple paging identifiers in the paging message.

In some examples, POs and PFs may be spread evenly across a time domain. The distribution may prevent a RAN node (e.g., an NE 102) from entering deeper sleep modes because the RAN node may wake up to transmit paging messages, even if the paged UEs 104 are not within the cell coverage area. The location of idle mode UEs 104 may be known at a registration area level, which may include one or more tracking areas that the UE 104 receives in a registration accept message. A UE 104 may use DRX in an RRC idle mode (e.g., RRC_IDLE) and RRC inactive mode (e.g., RRC_INACTIVE) to reduce power consumption. The UE 104 may monitor one PO per DRX cycle. A PO may include a set of PDCCH monitoring occasions and may include multiple time slots, such as subframes or OFDM symbols, where the NE 102 may transmit paging downlink control information (DCI).

In some cases, the NE 102 may transmit paging messages using multiple beams to provide coverage across different spatial directions, where each beam may carry the same paging content to enable UEs 104 in different locations to receive the paging message. For example, in multi-beam operations, the UE 104 may assume that the NE 102 repeats the same paging message and the same short message in each of the transmitted beams. Thus, the selection of the beam or beams for reception of the paging message and short message may be determined by a UE 104. The paging message may be the same for both RAN-initiated paging and CN-initiated paging. RAN-initiated paging refers to paging that originates from the radio access network, where the NE 102 initiates the paging procedure to notify a UE 104 in RRC inactive mode of pending downlink data or to request the UE 104 to resume an RRC connection. CN-initiated paging refers to paging that originates from the CN 106, where the CN 106 requests the NE 102 to page a UE 104 in RRC idle mode or RRC inactive mode to notify the UE 104 of incoming calls, mobile-terminated data, or other network events that result in the UE 104 establishing or resuming a connection. The UE 104 may initiate an RRC connection resume procedure upon receiving RAN-initiated paging. If the UE 104 receives CN-initiated paging in RRC_INACTIVE state, then the UE 104 may move to RRC_IDLE state and inform the non-access stratum (NAS).

In some cases, NEs 102 and/or UEs 104 may determine the PF and PO for paging. For example, the NEs 102 and/or the UEs 104 may determine a system frame number (SFN) for the PF according to Equation 1:

(SFN+PF_{offset})mod(T)=(T div N)*(UE_{ID} mod(N)), (1)

where T represents the DRX cycle of the UE 104, N represents the number of total paging frames in T, PF_{offset} represents an offset used for PF determination, and UE_{ID} represents an identifier that uniquely identifies the UE 104. The index, iₛ, that indicates the PO within the PF may be determined by Equation 2:

$${i}_{s} = floor ( \frac{U {E}_{ID}}{N} ) mod Ns , \qquad ( 2 )$$

where Ns represents the number of POs for a PF. The UE 104 may determine the PO using the index iₛ and the number of actual transmitted SSBs determined according to SSB positions in burst information in SIB1. The UE 104 may sequentially number the PDCCH monitoring occasions for paging that do not overlap with uplink symbols from zero, starting from the first PDCCH monitoring occasion for paging in the PF.

For example, the PDCCH monitoring occasions for paging are determined according to one or more defined configurations, including pagingSearchSpace, firstPDCCH-MonitoringOccasionOfPO, and nrofPDCCH-MonitoringOccasionPerSSB-InPO. If a value of SearchSpaceId is zero for pagingSearchSpace, then the PDCCH monitoring occasions for paging are the same as for remaining minimum system information (RMSI). If the value of SearchSpaceId is zero for pagingSearchSpace, Ns has a value of either one or two. If Ns is one, then there is one PO that starts from the first PDCCH monitoring occasion for paging in the PF. If Ns is two, then the PO is either in the first half frame (e.g., iₛ=0) or the second half frame (e.g., iₛ=1) of the PF. If SearchSpaceId has a value other than zero for pagingSearchSpace, then the UE monitors the (iₛ+1)^{th} PO. A PO is a set of S*X consecutive PDCCH monitoring occasions, where S is the number of actual transmitted SSBs determined according to ssb-PositionsInBurst in SIB1 and X is the nrofPDCCH-MonitoringOccasionPerSSB-InPO if configured or is equal to one otherwise. The (x*S+K)^{th} PDCCH monitoring occasion for paging in the PO corresponds to the Kth transmitted SSB, where x=0, 1, . . . , X−1, K=1, 2, . . . , S. The PDCCH monitoring occasions for paging that do not overlap with uplink symbols (e.g., determined according to tdd-UL-DL-ConfigurationCommon) are sequentially numbered from zero, starting from the first PDCCH monitoring occasion for paging in the PF. If the firstPDCCH-MonitoringOccasionOfPO is present, then the starting PDCCH monitoring occasion number of (iₛ+1)^{th} PO is the (iₛ+1)^{th} value of the firstPDCCH-MonitoringOccasionOfPO parameter. Otherwise, the starting PDCCH monitoring occasion number is equal to iₛ*S*X. If X>1, then if the UE 104 detects a PDCCH transmission addressed to a paging-radio network temporary identifier (P-RNTI) within the PO, the UE 104 may not monitor the subsequent PDCCH monitoring occasions for the PO. In some cases, a PO associated with a PF may start in the PF or after the PF. The PDCCH monitoring occasions for a PO can span multiple radio frames. If a SearchSpaceId other than zero is configured for paging-SearchSpace, then the PDCCH monitoring occasions for a PO can span multiple periods of the paging search space.

The UE 104 may determine the DRX cycle T differently depending on whether the UE 104 operates in extended DRX (eDRX) mode. The eDRX mode is a power-saving mechanism that enables the UE 104 to use longer DRX cycles than standard DRX, providing for the UE 104 to remain in a low-power state for extended periods between paging monitoring occasions. If the UE 104 does not operate in eDRX, then the UE 104 may determine T by the shortest of the UE-specific DRX values, if configured by RRC signaling or upper layers or provided in sidelink (PC5) RRC signaling, and a default DRX value broadcast in system information. In RRC_IDLE state, if the UE operates in eDRX and eDRX is configured by upper layers (e.g., T_{eDRX,CN}), and if T_{eDRX,CN} is less than a threshold numerical quantity of radio frames (e.g., 1024 radio frames), then T is equal to T_{eDRX,CN}. For example, if the UE 104 operates in eDRX and upper layers configure eDRX, then the UE 104 may determine T depending on whether the eDRX value is no longer than a threshold numerical quantity of radio frames (e.g., 1024 radio frames). If upper layers do not configure the UE-specific DRX, then the UE 104 may apply a default value. During a CN-configured paging time window (PTW), the UE 104 may determine T by the shortest of the UE-specific DRX value and the default DRX value broadcast in system information.

In RRC_INACTIVE state, the UE may operate in eDRX, where eDRX is configured by RRC (e.g., T_{eDRX,RAN}), and/or upper layers (e.g., T_{eDRX,CN}). If both T_{eDRX,CN} and T_{eDRX,RAN} are no longer than 1024 radio frames, T=min{T_{eDRX,RAN}, T_{eDRX,CN}}. If T_{eDRX,CN} is no longer than 1024 radio frames and no T_{eDRX,RAN} is configured or used, T is determined by the shortest of UE-specific DRX value configured by RRC and T_{eDRX,CN}. If T_{eDRX,CN} is longer than 1024 radio frames, then if T_{eDRX,RAN} is not configured or used, then during a CN-configured PTW, T is determined by the shortest of one or more UE-specific DRX values, if configured by RRC and/or upper layers, and a default DRX value broadcast in system information. Outside the CN-configured PTW, T is determined by the UE-specific DRX value configured by RRC. If T_{eDRX,RAN} is used and no longer than 1024 radio frames, then during the CN-configured PTW, T is determined by the shortest of the UE-specific DRX value, if configured by upper layers and T_{eDRX,RAN}, and a default DRX value broadcast in system information. Outside the CN-configured PTW, T is determined by T_{eDRX,RAN}.

The UE 104 may derive the UE_{ID} from a 5G-S-TMSI, which is a 48-bit identifier (e.g., a string value). If the UE 104 operates in eDRX, then the UE 104 may calculate the UE_{ID} as 5G-S-TMSI mod 4096. Otherwise, the UE 104 may calculate the UE_{ID} as 5G-S-TMSI mod 1024. The UE 104 may interpret 5G-S-TMSI as a binary number, where the left most bit represents the most significant bit. If the UE 104 has no 5G-S-TMSI, for example, if the UE 104 has not registered with the network, then the UE 104 may use a default identity of zero (e.g., UE_{ID}=0) in Equations 1 and 2. The NE 102 may signal parameters, including Ns, nAndPagingFrameOffset, nrofPDCCH-MonitoringOccasionPerSSB-InPO, and the length of the default DRX cycle, in SIB1. The UE 104 may derive the values of N and PF_{offset} from the parameter nAndPagingFrameOffset. The NE 102 may signal the parameter firstPDCCH-MonitoringOccasionOfPO in SIB1 for paging in a bandwidth part (BWP) configured by initialDownlinkBWP, and for paging in a downlink BWP other than the BWP configured by initialDownlinkBWP, the NE 102 may signal the parameter in the corresponding BWP configuration. A BWP refers to a contiguous set of physical resource blocks on a given carrier that a UE 104 may use for transmission or reception. The NE 102 may configure one or more BWPs for the UE 104, including an initial downlink BWP for initial access and paging operations.

In the RRC_INACTIVE state, if the UE 104 supports inactiveStatePO-Determination and the NE 102 broadcasts ranPagingInIdlePO with value “true,” then the UE 104 may use the same iₛ as for RRC_IDLE state. Otherwise, the UE 104 determines the is based on the parameters and Equation 2. In the RRC_INACTIVE state, if eDRX values configured by upper layers are less than 1024 radio frames, then the UE 104 may use the same iₛ as for RRC_IDLE state. In the RRC_INACTIVE state, if eDRX values configured by upper layers are greater than 1024 radio frames, during CN PTW, the UE 104 may use the same iₛ as for RRC_IDLE state. Outside CN PTW, the UE 104 may use the iₛ for RRC_INACTIVE state.

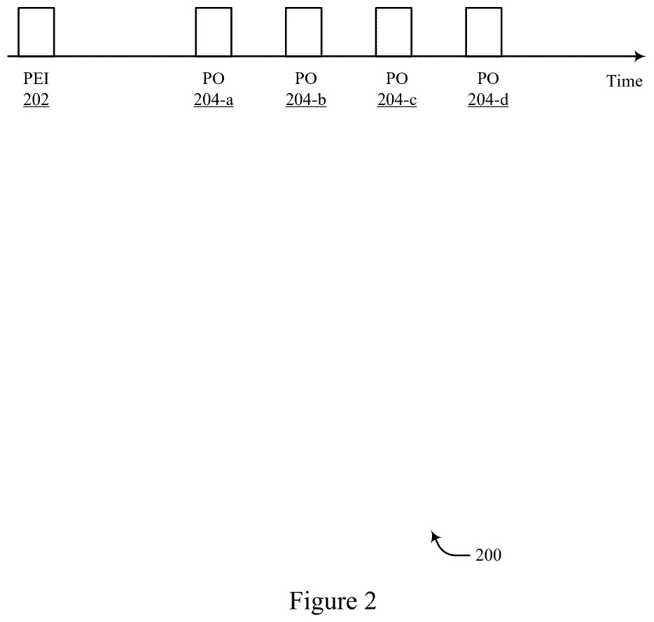

In some examples, to reduce paging-related energy consumption, an NE 102 may use more sporadic paging frames by extending the values of N to increase the interval between PFs, such as T/64 or T/128, and compensating for the decrease in the number of PFs by increasing the number of POs per PF. However, this approach may still utilize the same number of transmissions from the NE 102, because the total number of POs before and after the enhancement may remain the same, leading to approximately the same energy consumption. The NE 102 may use a paging early indication (PEI) to create subgrouping of POs and wake one or more POs linked to the PEI, which is described in further detail with respect to FIG. 2. The PEI may be a DCI format 2_7 that includes codepoints for the subgroups, and each PO may include a paging monitoring occasion, which includes DCI 1_0 monitoring occasions.

An NE 102 may expend energy in transmitting SSBs, a PBCH, including a MIB, SIB1, other system information, and paging messages. The NE 102 may provide SIBs other than SIB1 on demand in 5G networks. Transmission of SSBs and SIB1 may be useful for cell identification and idle mode and connected mode mobility. Energy consumption from constant paging transmission may be unnecessary, such as if few or none of the UEs 104 being paged are actually present in a cell that is attempting to conserve energy. In some cases, if the NE 102 and/or a UE 104 perform paging operations within clustered signaling periods, then the allocation of POs relative to other signaling within the clustered signaling period may be unclear, potentially resulting in inefficient resource utilization or misalignment between the UE 104 and the NE 102. For example, without a defined relationship between a paging cycle and the periodicity of the clustered signaling periods, and without a defined paging offset relative to other signaling in the clustered signaling periods (e.g., an SSB), the UE 104 may be unable to accurately determine when to monitor for paging messages within the clustered signaling period. The uncertainty may lead to missed paging messages if the UE 104 monitors incorrect time periods, or may result in unnecessary power consumption if the UE 104 monitors for paging messages during clustered signaling periods that do not include paging messages intended for the UE 104. Additionally, or alternatively, the NE 102 may be unable to efficiently schedule paging transmissions within the clustered signaling framework, potentially causing the NE 102 to remain in an active state longer or to transmit paging messages at times when the intended UEs 104 are not monitoring.

According to implementations, one or more of the NEs 102 and the UEs 104 are operable to implement various aspects of the techniques described with reference to the present disclosure. An NE 102 (e.g., a base station, gNB) transmits information for paging in clustered signaling periods 108 to a UE 104. The information for paging in clustered signaling periods 108 indicates a periodicity that defines a set of clustered signaling periods, a relationship between the periodicity and a paging cycle that defines at least one paging message, and a paging offset measured relative to an SSB within at least one clustered signaling period of the set of clustered signaling periods. The relationship between the periodicity and the paging cycle enables the UE 104 to determine which clustered signaling periods include paging messages intended for the UE 104, while the paging offset relative to the SSB provides a reference point for locating POs within the clustered signaling period. For example, the UE 104 determines a current cluster index by applying an SFN and the periodicity, and determines at least one cluster index that identifies the at least one clustered signaling period by applying the current cluster index and the relationship between the periodicity and the paging cycle. The UE 104 uses the paging offset relative to the SSB to determine a paging start time that indicates at least one PO within the at least one clustered signaling period. The NE 102 transmits a paging message 110 to the UE 104 during the at least one PO within the at least one clustered signaling period according to the paging offset relative to the SSB. The UE 104 receives the paging message 110 during the at least one PO by monitoring the correct time-frequency resources identified using the information for paging in clustered signaling periods 108.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 may be implemented by one or more UEs and/or NEs, which may be an example of NEs 102 and UEs 104, as described with reference to FIG. 1. The transmission diagram 200 illustrates an example of using a PEI 202 to create subgrouping of POs.

The transmission diagram 200 includes a PEI 202 and a set of POs in the time domain, such as PO 204-a, PO 204-b, PO 204-c, and PO 204-d. The PEI 202 indicates to UEs whether paging messages are present in subsequent POs. For example, the PEI 202 may be a DCI format 2_7 that includes codepoints for subgroups of UEs, enabling a UE to determine whether to continue monitoring the subsequent POs or to return to an inactive state. The PO 204-a, the PO 204-b, the PO 204-c, and the PO 204-d include time-frequency resources allocated for paging message transmissions, as described with reference to FIG. 1. For example, the POs may be used by an NE to transmit paging messages to notify UEs of incoming data or other events. A UE may monitor the PEI 202 to determine whether the UE belongs to a subgroup that is being paged, and if so, the UE may continue monitoring one or more of the PO 204-a, the PO 204-b, the PO 204-c, and the PO 204-d for paging messages. If the PEI 202 indicates that the UE is not being paged, then the UE may return to an inactive state without monitoring the subsequent POs.

In some examples, the transmission diagram 200 illustrates a sequential arrangement where the PEI 202 is transmitted prior to the PO 204-a, the PO 204-b, the PO 204-c, and the PO 204-d. The PO 204-a, the PO 204-b, the PO 204-c, and the PO 204-d may be clustered together within a signaling period, enabling the NE to transition between active and inactive states for improved energy efficiency. Each of the PO 204-a, the PO 204-b, the PO 204-c, and the PO 204-d may include a paging monitoring occasion during which the UE monitors for DCI 1_0 that schedules a paging message. The subgrouping of POs using the PEI 202 enables the NE to wake the POs linked to the PEI 202 that correspond to UEs being paged, reducing unnecessary monitoring by UEs that are not being paged. The clustered arrangement of the PO 204-a, the PO 204-b, the PO 204-c, and the PO 204-d within the signaling period, combined with the PEI 202, provides for both the NE and the UE to conserve energy by reducing the duration of active states and enabling transitions to inactive states when paging messages are not expected. However, without a defined relationship between the paging cycle and the periodicity of the clustered signaling periods, and without a defined paging offset relative to other signaling in the clustered signaling periods (e.g., an SSB), the allocation of POs relative to other signaling within the clustered signaling period may be unclear, potentially resulting in inefficient resource utilization or misalignment between the UE and the NE. The NE may define a relationship between the paging cycle and the periodicity of the clustered signaling periods, as well as a paging offset relative to an SSB, enabling the UE to accurately determine when to monitor for paging messages within the clustered signaling period.

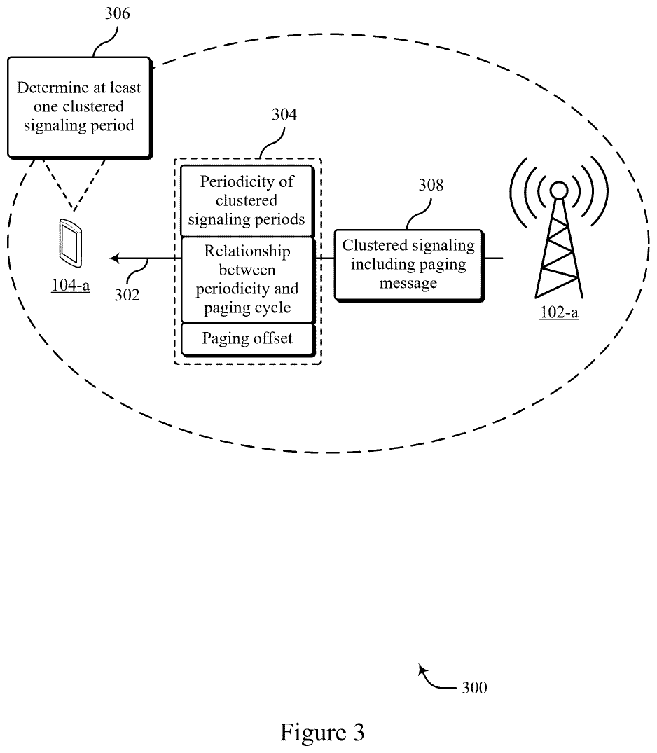

FIG. 3 illustrates an example of a wireless communications system 300 in accordance with aspects of the present disclosure. In some examples, the wireless communications system 300 implements aspects of the wireless communications system 100 and/or the transmission diagram 200. For example, the wireless communications system 300 includes an NE 102-a and a UE 104-a, which may be examples of an NE 102 and a UE 104 as described with reference to FIG. 1. In some examples, the UE 104-a and the NE 102-a may exchange signaling. For example, the NE 102-a may transmit signaling to the UE 104-a via a downlink communications link 302, which may be an example of a communications link as described with reference to FIG. 1. In some other examples, the UE 104-a may transmit signaling to the NE 102-a via an uplink communications link, which may be an example of a communications link as described with reference to FIG. 1. The signaling between the UE 104-a and the NE 102-a may include control signaling and/or data transmissions.

The NE 102-a transmits signaling 304 to the UE 104-a via the downlink communications link 302. The signaling 304 indicates information for paging in clustered signaling periods. For example, the signaling 304 may include a periodicity defining a set of clustered signaling periods, a relationship between the periodicity and a paging cycle for at least one paging message, and a paging offset measured relative to an SSB within at least one clustered signaling period of the set of clustered signaling periods. The signaling 304 may be transmitted via system information, such as in a MIB, SIB1, or other broadcast signaling, to enable the UE 104-a to determine when to transition to an active state for monitoring the clustered signaling period.

In some examples, the NE 102-a may indicate the periodicity as a numerical value representing a time duration, such as 20 ms, 40 ms, 80 ms, 160 ms, or 320 ms. The periodicity may be signaled using a dedicated information element (IE) in SIB1, such as a clusterPeriodicity field that includes an enumerated value corresponding to one of the supported periodicity values. The relationship between the periodicity and the paging cycle may be indicated using a ratio or multiplier field, such as a pagingCycleToClusterRatio IE that indicates whether the paging cycle is equal to the periodicity (e.g., a value of 1), a multiple of the periodicity (e.g., values of 2, 4, or 8 indicating the paging cycle is 2, 4, or 8 times the cluster periodicity), or a fraction of the periodicity (e.g., values of ½ or ¼ indicating the paging cycle is half or one quarter of the cluster periodicity). The paging offset relative to the SSB may be indicated as a time offset value in units of symbols or slots, such as a pagingOffsetFromSSB field that indicates the number of symbols or slots from the start of the first SSB in the clustered signaling period to the start of the first PO. For example, the paging offset may be indicated as an integer value ranging from 0 to a maximum value determined by the duration of the clustered signaling period, where a value of 0 indicates that the first PO begins immediately after the SSB, and larger values indicate increasing delays between the SSB and the first PO.

At 306, the UE 104-a determines at least one clustered signaling period during which to monitor for paging messages. For example, the UE 104-a may determine a current cluster index by applying an SFN and the periodicity, and may determine at least one cluster index identifying the at least one clustered signaling period by applying the current cluster index and the relationship between the periodicity and the paging cycle. In some examples, the UE 104-a may apply a hash function to an identifier of the UE 104-a (e.g., a TMSI) to determine a hashed identifier, where the current cluster index identifies the at least one clustered signaling period when the current cluster index matches the hashed identifier. The hash function enables UEs to be uniformly distributed across cluster indices, reducing congestion during paging monitoring. The NE 102-a may perform corresponding processing to determine the at least one clustered signaling period during which to transmit paging messages. For example, the NE 102-a may determine a current cluster index using an SFN and the periodicity, and may determine at least one cluster index that is mapped to the at least one clustered signaling period using the current cluster index and the relationship between the periodicity and the paging cycle. In some examples, the NE 102-a may apply a hash function to identifiers of a set of UEs (e.g., TMSIs) to determine respective hashed identifiers, where the current cluster index maps to the at least one clustered signaling period when the current cluster index matches at least one hashed identifier of the respective hashed identifiers. The NE 102-a may use the determined cluster indices to determine which UEs are expected to monitor for paging messages during each clustered signaling period. In some examples, a clustered signaling period may be referred to as a signaling cluster, a common channel cluster, a cell-common signaling window, an active signaling burst, or a consolidated transmission period, among other example terminology.

The NE 102-a transmits clustered signaling including paging message 308 to the UE 104-a during the at least one clustered signaling period. The clustered signaling including paging message 308 includes common channels and signals, such as SSBs, broadcast control channels, system information, and paging messages, that are transmitted in a burst during the clustered signaling period. Prior to transmitting the clustered signaling including paging message 308, the NE 102-a may switch to an active state from an inactive state during the at least one clustered signaling period. In the active state, the NE 102-a may activate transmitter chains, power up radio frequency components, and prepare resources for transmission of the clustered signaling. The NE 102-a may determine the at least one PO within the at least one clustered signaling period using the paging offset relative to the SSB, and may schedule the at least one paging message for transmission during the determined PO. The UE 104-a receives the at least one paging message during at least one PO within the at least one clustered signaling period using the paging offset relative to the SSB. For example, the UE 104-a determines a paging start time by referencing a start of the SSB and the paging offset, where the paging start time indicates the at least one PO. The UE 104-a may switch to an active state from an inactive state during the at least one clustered signaling period, monitor the at least one PO for the at least one paging message, and switch back to the inactive state after monitoring to conserve power. The NE 102-a may switch back to the inactive state after transmitting the clustered signaling, including paging message 308, to conserve power, where the inactive state may involve deactivating transmitter chains, reducing power to radio frequency components, or entering a low-power mode until the next clustered signaling period.

In the case of clustered transmission and reception of common channels and signals, an idle mode DRX cycle (I_{DRX}) or paging cycle may be defined in terms of units of cluster periodicity. The paging cycle may be equal to, a multiple of, or a fraction of the cluster periodicity. The I_{DRX} cycle is the DRX cycle that the UE 104-a uses when operating in RRC idle mode or RRC inactive mode. The I_{DRX} cycle may be equivalent to the paging cycle, as both define the periodicity at which the UE wakes up from a low-power state (e.g., inactive state) to monitor for paging messages. The I_{DRX} cycle may be configured by the NE 102-a via system information or by upper layers. The NE 102-a may transmit signaling 304 to the UE 104-a that includes the periodicity of clustered signaling periods and the relationship between the periodicity and the paging cycle. Based on the relationship, the UE 104-a may wake up in each paging cycle and/or at one or more defined cluster numbers to monitor for an early paging message using a downlink wake-up signal (WUS) or to directly monitor for a paging message. For example, if I_{DRX} is four times the cluster period, where the cluster period is 160 ms, then the UE 104-a may wake up every fourth cluster period, which is 640 ms. In some other examples, if I_{DRX} is one half of the cluster period, where the cluster period is 160 ms, then the UE 104-a may wake up twice within a cluster, which is every 80 ms. The NE 102-a may define the cluster periodicity in remaining minimum system information (RMSI) (e.g., MIB, SIB0, or SIB1), and the I_{DRX} cycle and/or paging cycle in terms of multiples or ratios of the cluster periodicity.

The SSB may be defined as the relative time anchor for paging frames or POs within a cluster, where the first symbol of the first SSB at the beginning of the cluster period may be a reference value. The paging offset included in the signaling 304 may be defined relative to the SSB, enabling the UE 104-a to determine the at least one clustered signaling period during which to monitor for paging messages. In some cases, paging may be limited to one or more cluster indices rather than radio frames, such that UEs monitor the cluster indices according to the paging cycle. Additionally, or alternatively, a UE identifier may be used with a hash function, such that cluster indices for UEs to monitor may be uniformly distributed across cluster numbers. Each UE may monitor one or more defined cluster indices derived from the UE identifier. Each UE may wake up to monitor according to the paging cycle, which may be commonly configured across each UE within a cell.

A cluster index (e.g., Cluster_{ID}) may be derived from absolute time (e.g., SFN with a value of zero) by dividing the radio frame number, according to Equations 3, 4, and 5:

$${Custer}_{ID} = AbsoluteTime \frac{SFN}{ClusterPeriod} , \qquad ( 3 )$$

$$PagingCluster = \frac{{Cluster}_{ID} mod ( {I}_{D R X} cycle )}{pagingCycle} , \qquad ( 4 )$$

$$PagingStart = {SSB}_{start} + {Paging}_{Offset} . \qquad ( 5 )$$

In some examples, the UE 104-a and/or the NE 102-a may use a hash-based mapping between a UE identity and a cluster index. For example, the UE 104-a and/or the NE 102-a may use the UE identity as a hash function to determine the cluster identity, such that each UE may monitor a different cluster identity according to the UE identity (e.g., TMSI), while the cluster periodicity and paging cycle are commonly indicated. In some cases, Tc is a cluster periodicity (e.g., 160 ms), TDRX is a paging cycle expressed in number of clusters, CI is a current cluster index, UE_{ID} is determined as a function of TMSI (e.g., UE_{ID}=TMSI mod 1024), Nc is a number (e.g., numerical quantity, amount) of paging clusters in one I_{DRX} cycle. The current cluster index (e.g., CI) may be determined according to Equation 3.

In some examples, a hash function may be defined according to Equation 6:

H(UE_{ID})=UE_{ID} mod Nc. (6)

The UE 104-a monitors a cluster when the condition, CI mod Nc=H(UE_{ID}), is met. This approach ensures that each UE is mapped deterministically to one cluster within the DRX cycle, and that different UEs are uniformly distributed across clusters.

In some other examples, the hash function may be defined according to Equation 7:

H(UE_{ID})=(a×UE_{ID}+b)mod Nc, (7)

where a is relatively prime to Nc, and b is an optional offset. The UE 104-a monitors a cluster if the condition, CI mod Nc=(a×UE_{ID}+b) mod Nc, is true.

In some other examples, the hash function may be defined according to Equation 8:

$$H ( {UE}_{ID} ) = ⌊ \frac{( {UE}_{ID} \times Nc )}{1024} ⌋ . \qquad ( 8 )$$

The UE 104-a monitors a cluster if the condition, CI mod Nc=H(UE_{ID}), is true. For example, the cluster periodicity may have a value of 160 ms, a DRX cycle may have a value of 4 clusters (e.g., Nc=4), and a UE_{ID} may have a value of 37 (e.g., UE_{ID}=37). Using a simple modulo hash function, H(37)=37 mod 4=1. The UE 104-a monitors a cluster if CI mod 4=1. For example, if the cluster index has a value of 9, then 9 mod 4=1. Thus, the UE 104-a may determine the at least one clustered signaling period at 306 by applying the hash function to the UE identity to identify the cluster index of the clustered signaling period during which to monitor for the clustered signaling including paging message 308. If the condition is satisfied (e.g., the current cluster index matches the cluster index identified by the hash function), then the UE 104-a wakes up to monitor for paging messages during the cluster with the cluster index of value 9. For example, the current cluster index represents the cluster that is presently occurring according to the system timing, while the hashed identifier derived from the UE identity represents the cluster within the DRX cycle that the UE is assigned to monitor. The UE compares the two values by evaluating whether the current cluster index, when reduced modulo the number of paging clusters in the DRX cycle, equals the hashed identifier. If the comparison results in a match, then the UE 104-a determines that the current cluster is the clustered signaling period during which the UE 104-a transitions to an active state and monitors for the clustered signaling including the paging message 308.

In some examples, the NE 102-a may transmit a single paging message that includes paging identifiers for multiple UEs, where each UE monitors the paging message and determines whether the paging message is addressed to the UE based on the paging identifiers included in the message. Additionally, or alternatively, the NE 102-a may transmit multiple paging messages during the clustered signaling period, where each paging message is transmitted during a different PO within the clustered signaling period. The number of paging messages transmitted during the clustered signaling period may depend on the number of UEs being paged, the capacity of each paging message, and the number of POs available within the clustered signaling period.

The NE 102-a may configure the number of POs within each clustered signaling period via system information, such as in SIB1 or other broadcast signaling. For example, the NE 102-a may indicate a parameter that indicates the number of POs per cluster, enabling the UE 104-a to determine how many POs are available for paging message reception within each clustered signaling period. The NE 102-a may also indicate the time domain and frequency domain locations of the POs within the clustered signaling period relative to the SSB. In some cases, the NE 102-a may aggregate paging messages for multiple UEs into a single paging message to reduce signaling overhead and improve resource efficiency. The aggregated paging message may include a list of paging identifiers, such as 5G-S-TMSIs, corresponding to the UEs being paged. Each UE monitors the paging message and compares the paging identifiers in the message with the paging identifier of the UE to determine whether the paging message is intended for the UE. In some other cases, the NE 102-a may transmit separate paging messages for different groups of UEs, where each group of UEs is associated with a different PO within the clustered signaling period. The grouping of UEs may be based on UE identifiers, subgroup indices, or other criteria configured by the NE 102-a.

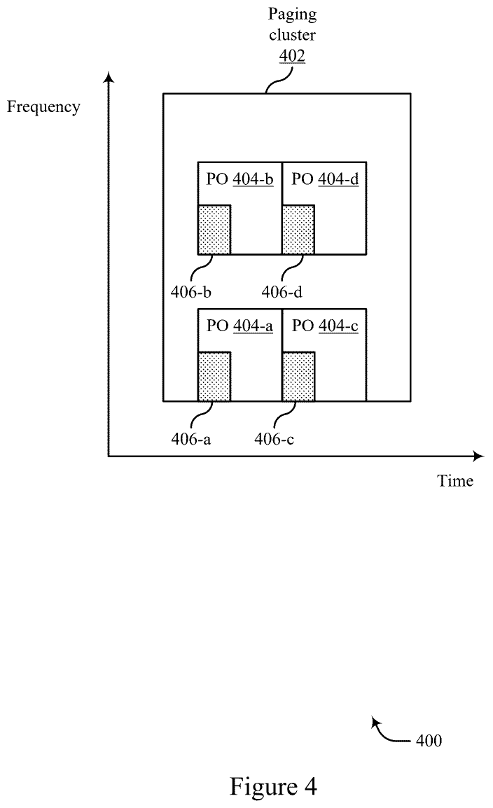

FIG. 4 illustrates an example of a resource diagram 400 in accordance with aspects of the present disclosure. In some examples, the resource diagram 400 implements or is implemented by aspects of the wireless communications system 100, the transmission diagram 200, and/or the wireless communications system 300. For example, the resource diagram 400 may be implemented by one or more UEs and/or NEs, which may be an example of NEs 102 and UEs 104, as described with reference to FIG. 1. The resource diagram 400 illustrates an example of time and frequency resource allocation within a paging cluster 402.

The paging cluster 402 includes a set of POs that are distributed across both time and frequency domains within the clustered signaling period. For example, the paging cluster 402 includes PO 404-a, PO 404-b, PO 404-c, and PO 404-d, where each PO corresponds to time-frequency resources allocated for paging message transmission. The PO 404-a includes a paging message 406-a, the PO 404-b includes a paging message 406-b, the PO 404-c includes a paging message 406-c, and the PO 404-d includes a paging message 406-d.

In some examples, the POs within the paging cluster 402 may be arranged using time-division multiplexing (TDM), frequency-division multiplexing (FDM), or a combination of TDM and FDM. TDM refers to an arrangement where multiple POs are allocated at different time locations within the paging cluster 402, such that the POs are separated in the time domain. FDM refers to an arrangement where multiple POs are allocated at different frequency locations within the paging cluster 402, such that the POs are separated in the frequency domain. As illustrated in the resource diagram 400, the PO 404-b and the PO 404-a are positioned at a first time location within the paging cluster 402 and are separated in the frequency domain. The PO 404-d and the PO 404-c are positioned at a second time location within the paging cluster 402 and are separated in the frequency domain. The PO 404-a and the PO 404-c are positioned at a first frequency location within the paging cluster 402 and are separated in the time domain. The PO 404-b and the PO 404-d are positioned at a second frequency location within the paging cluster 402 and are separated in the time domain. The combination of TDM and FDM enables the NE 102-a to allocate a greater number of POs within the paging cluster 402, providing for increased paging capacity and enabling UEs to be distributed across both time and frequency resources.

The UE 104-a may determine which PO to monitor within the paging cluster 402 based on a UE identifier and a hash function. For example, the hash function may map the UE identifier to a time domain index and a frequency domain index, where the time domain index identifies the time location of the PO and the frequency domain index identifies the frequency location of the PO. The NE 102-a may indicate the number of TDM POs and the number of FDM POs within each paging cluster 402 via system information, enabling the UE 104-a to determine the total number of POs and to apply the hash function to identify the specific PO for monitoring.

For example, a UE may select the cluster index by applying a hash function to an identifier of the UE (e.g., a UE identifier, a 5G-S-TMSI) and the relationship between the periodicity and the paging cycle. The hash function may map the identifier to a cluster index value that identifies which clustered signaling period the UE is to monitor for paging messages. In some examples, the UE may determine a current cluster index using an SFN and the periodicity, as described with reference to FIG. 3. The UE may compare the current cluster index to the hashed identifier to determine whether the current clustered signaling period corresponds to a PO for the UE. The UE may select the PO within a paging cluster by applying a hash function to the identifier of the UE. The hash function maps the identifier to at least one of a time domain index or a frequency domain index of the PO within the paging cluster. The UE may extract the time domain and frequency domain indices. The time domain index may indicate a time slot or symbol within the paging cluster at which the UE is to monitor for paging messages, and the frequency domain index may indicate a frequency resource or subcarrier at which the UE is to monitor for paging messages. In some examples, Nt is a number (e.g., numerical quantity, amount) of TDMed POs per cluster and Nf is a number of FDMed POs per time PO.

For cluster determination, the UE may determine whether to monitor a cluster according to the condition, CI mod Nc=HC(UE_{ID}). The hash function HC(UE_{ID}) may be computed according to Equation 9:

$$Hc ( {UE}_{ID} ) = \frac{⌊ {UE}_{ID} * Nc ⌋}{1024} . \qquad ( 9 )$$

For PO determination within a cluster, the UE may apply a hash function according to Equation 10:

$$HPO ( {UE}_{ID} ) = \frac{[ {UE}_{ID} * ( Nt * Nf ) ]}{1024} , \qquad ( 10 )$$

where the value of HPO is constrained, such that 0 is less than or equal to HPO and HPO is less than the product of Nt and Nf (e.g., 0≤HPO<(Nt*Nf)). To extract time and frequency domain indices, the time offset may be determined from PO_{time offset}(iₜ) and the frequency resource may be determined from PO_{frequency offset}(i_{f}), where the time index, iₜ, is computed as

$${i}_{t} = \frac{HPO}{Nf}$$

(e.g., where 0 is less than or equal to iₜ and iₜ is less than Nt, 0≤iₜ<Nt), and the frequency index, i_{f}, is computed as HPO mod Nf (e.g., where 0 is less than or equal to i_{f} and i_{f} is less than Nf, 0≤i_{f}<Nf).

As an illustrative example, assume a cluster periodicity of 160 ms, a DRX cycle spanning 4 clusters (e.g., Nc equals 4), Nt equals 2 TDMed POs per cluster, Nf equals 4 FDMed POs per time PO, resulting in a total of 8 POs per cluster, and a UE_{ID} of 37. Applying the cluster determination hash function, Hc(37),

$$H c ( 37 ) = \frac{[ 37 \times 4 ]}{1024} = 0 .$$

Therefore, the UE monitors a cluster when CI mod 4=0. Applying the PO determination hash function, Hpo(37),

$$Hpo ( 37 ) = \frac{[ 37 \times 8 ]}{1024} = 0.$$

Thus, iₜ equals 0 and i_{f} equals 0, meaning the UE monitors the first time domain PO and the first frequency domain PO.

In other examples, if complexity is less critical, then the time index it may be computed as (UE_{ID} mod Nt) and the frequency index if may be computed as

$$( ⌊ \frac{{UE}_{ID}}{Nt} ⌋ mod Nf ) .$$

Additionally, or alternatively, for a more symmetric distribution, the time index, iₜ, may be computed as (a·UE_{ID}+b) mod Nt, and the frequency index i_{f} may be computed as (c·UE_{ID}+d) mod Nf, where a and c are relatively prime to respective modulus values.

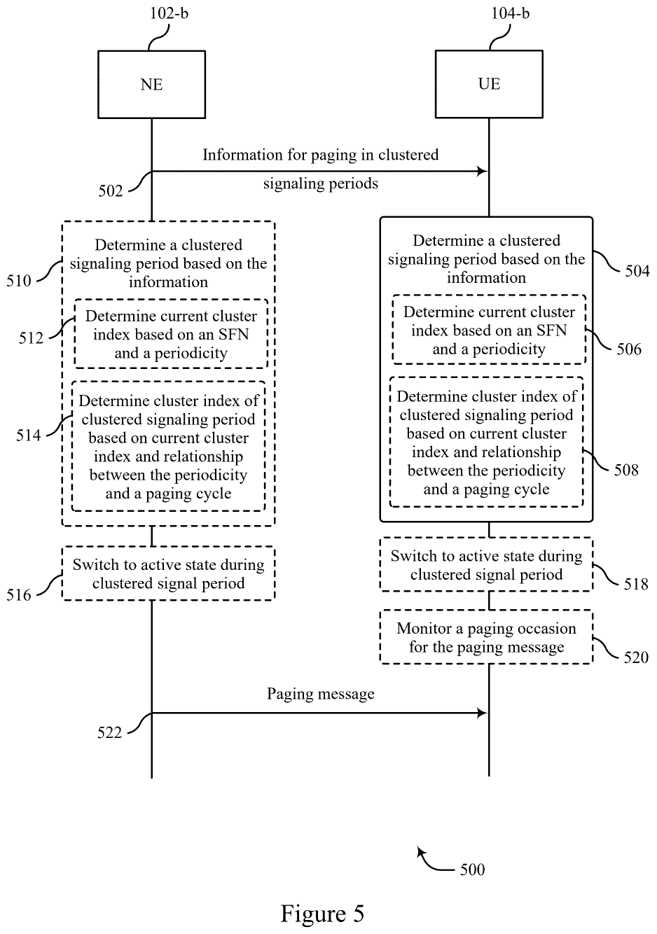

FIG. 5 illustrates an example of a signaling diagram 500 in accordance with aspects of the present disclosure. In some examples, the signaling diagram 500 implements or is implemented by aspects of the wireless communications system 100, the transmission diagram 200, the wireless communications system 300, and/or the resource diagram 400. The signaling diagram 500 may implement or be implemented by NE 102-b and UE 104-b, which may be examples of the corresponding devices as described with reference to FIGS. 1 and 3. For example, the NE 102-b may provide the UE 104-b with information for paging in clustered signaling periods. Alternative examples of the following may be implemented, where some processes are performed in a different order than described or are not performed. In some cases, processes may include additional features not mentioned below, or further processes may be added.

At 502, the NE 102-b transmits signaling to the UE 104-b. The signaling indicates a periodicity associated with a set of clustered signaling periods, indicates a relationship between the periodicity and a paging cycle associated with at least one paging message, and indicates a paging offset relative to an SSB associated with at least one clustered signaling period of the set of clustered signaling periods. The signaling may be transmitted via system information, such as in a MIB, SIB1, or other broadcast signaling. The periodicity may be indicated as a numerical value representing a time duration, such as 20 ms, 40 ms, 80 ms, 160 ms, or 320 ms. The relationship between the periodicity and the paging cycle may indicate that the paging cycle is one of equal to the periodicity, a multiple of the periodicity, or a fraction of the periodicity. For example, if the periodicity is 40 ms and the paging cycle is 80 ms, the relationship may indicate that the paging cycle is a multiple (e.g., two times) of the periodicity. The paging offset relative to the SSB may be indicated as a time offset value in units of symbols or slots from the start of the first SSB in the clustered signaling period to the start of the first PO. For example, the paging offset may be indicated as 14 symbols or 2 slots from the start of the first SSB. In some examples, the set of clustered signaling periods includes additional signaling that is common to a set of UEs, including the UE 104-b, and the additional signaling includes at least one of synchronization signals, broadcast control channels, system information, or random access channels.

At 504, the UE 104-b determines a clustered signaling period based on the signaling received at 502. The UE 104-b determines the at least one clustered signaling period based on the periodicity and the relationship between the periodicity and the paging cycle. For example, if the periodicity is 40 ms and the relationship indicates that the paging cycle is twice the periodicity (e.g., 80 ms), then the UE 104-b may determine that paging messages are transmitted every second clustered signaling period.

In some cases, at 506, the UE 104-b determines a current cluster index based on an SFN and the periodicity. In some examples, at 508, the UE 104-b determines a cluster index of the clustered signaling period based on the current cluster index and the relationship between the periodicity and the paging cycle. For example, if the current cluster index is 20 and the paging cycle is twice the periodicity, then the UE 104-b may determine that paging occurs at cluster indices 0, 2, 4, 6, etc., and thus the UE 104-b monitors for paging at cluster index 20 since 20 is an even number. In some examples, the UE 104-b determines at least one cluster index associated with the at least one clustered signaling period based on the current cluster index and the relationship between the periodicity and the paging cycle. In some other examples, the UE 104-b determines a hashed identifier associated with the UE 104-b based on a hash function and the relationship between the periodicity and the paging cycle. The current cluster index is associated with the at least one clustered signaling period based on the current cluster index matching the hashed identifier. The hash function may map a UE identifier (e.g., a TMSI) to a cluster index value, enabling UEs to be uniformly distributed across cluster indices.

In some cases, at 510, the NE 102-b determines a clustered signaling period based on the signaling. The NE 102-b may determine the at least one clustered signaling period during which to transmit paging messages based on the periodicity and the relationship between the periodicity and the paging cycle. For example, if the periodicity is 40 ms and the paging cycle is 80 ms, then the NE 102-b determines that paging messages are transmitted in alternating clustered signaling periods. At 512, the NE 102-b determines a current cluster index based on an SFN and the periodicity. The current cluster index may be derived from absolute time by dividing the radio frame number by the cluster period, as described with reference to Equation 3. At 514, the NE 102-b determines a cluster index of the clustered signaling period based on the current cluster index and the relationship between the periodicity and the paging cycle. In some examples, the NE 102-b determines at least one cluster index associated with the at least one clustered signaling period based on the current cluster index and the relationship between the periodicity and the paging cycle. In some other examples, the NE 102-b determines respective hashed identifiers associated with a set of UEs based on a hash function and the relationship between the periodicity and the paging cycle. The current cluster index is associated with the at least one clustered signaling period based on the current cluster index matching at least one hashed identifier of the respective hashed identifiers. For example, if the NE 102-b has UEs with hashed identifiers of 3, 7, and 12, and the current cluster index modulo 16 equals 7, then the NE 102-b transmits paging messages for the UE with hashed identifier 7 during the current clustered signaling period. The NE 102-b may use the determined cluster indices to determine which UEs are expected to monitor for paging messages during each clustered signaling period.

In some examples, at 516, the NE 102-b switches to an active state from an inactive state during the clustered signaling period. In the active state, the NE 102-b may activate transmitter chains, power up radio frequency components, and/or prepare resources for transmission of clustered signaling, including paging messages.

In some cases, at 518, the UE 104-b switches to an active state from an inactive state during the clustered signaling period. In the active state, the UE 104-b may activate receiver chains and prepare to monitor for paging messages.

In some examples, at 520, the UE 104-b monitors a PO for the paging message. The UE 104-b may determine the at least one PO within the at least one clustered signaling period and monitor the at least one PO for the at least one paging message. In some examples, the UE 104-b determines a paging start time based on a start of the SSB and the paging offset, where the paging start time corresponds to the at least one PO. In some examples, the UE 104-b applies a hash function to an identifier associated with the UE 104-b, where the hash function maps the identifier to at least one of a time domain index or a frequency domain index associated with the at least one PO, as described with reference to FIG. 4.

At 522, the NE 102-b transmits the at least one paging message to the UE 104-b during the at least one PO within the at least one clustered signaling period. The NE 102-b transmits the at least one paging message based on the paging offset relative to the SSB. For example, if the paging offset is 2 slots from the start of the SSB, then the NE 102-b transmits the paging message in the slot that is 2 slots after the start of the SSB. The UE 104-b receives the at least one paging message during the at least one PO based on the monitoring at 520. After transmitting the paging message, the NE 102-b may switch back to the inactive state to conserve power. After receiving the paging message, the UE 104-b may switch back to the inactive state to conserve power, or may initiate a connection establishment or connection resume procedure based on the paging message.

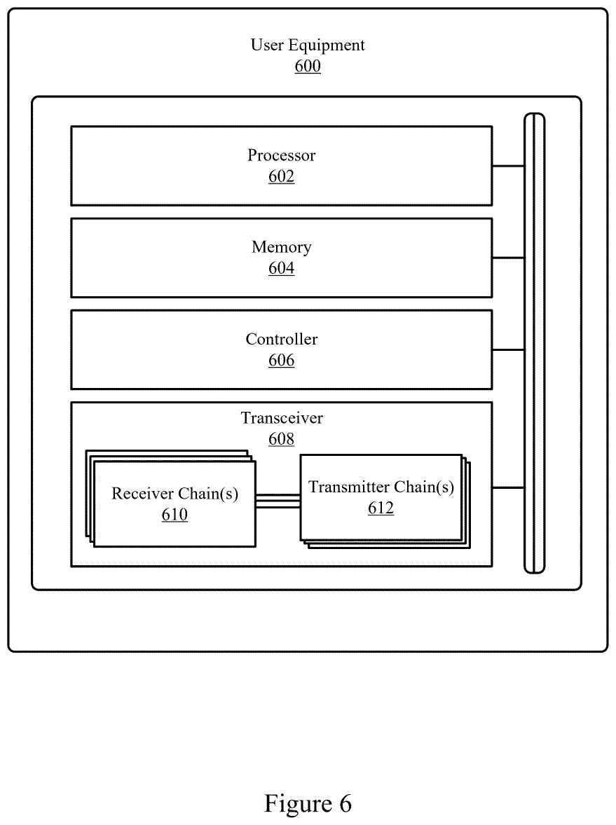

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field-programmable gate-array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, determining, based on the periodicity and the relationship between the periodicity and the paging cycle, the at least one clustered signaling period, and receiving, based on the paging offset relative to the SSB, the at least one paging message during at least one PO within the at least one clustered signaling period. By receiving signaling that indicates the periodicity, the relationship between the periodicity and the paging cycle, and the paging offset relative to the SSB, the UE 600 may provide for improved resource utilization, reduced power consumption, and enhanced paging reliability by enabling accurate determination of when to monitor for paging messages within clustered signaling periods.

Additionally, the UE 600 may be configured to or operable to support any one or combination of determining a current cluster index based on a system frame number and the periodicity, and determining at least one cluster index associated with the at least one clustered signaling period based on the current cluster index and the relationship between the periodicity and the paging cycle. By determining the current cluster index and the at least one cluster index, the UE 600 may efficiently identify which clustered signaling periods include paging messages intended for the UE 600, enabling the UE 600 to remain in an inactive state during other clustered signaling periods to conserve power. Additionally, or alternatively, the UE 600 may be configured to or operable to support determining a current cluster index based on a system frame number and the periodicity, and determining, based on a hash function and the relationship between the periodicity and the paging cycle, a hashed identifier associated with the UE, where the current cluster index is associated with the at least one clustered signaling period based on the current cluster index matching the hashed identifier. By using the hash function to determine the hashed identifier, the UE 600 may provide for efficient distribution of POs among multiple UEs and enable accurate identification of the clustered signaling periods associated with the UE 600.

Additionally, or alternatively, the UE 600 may be configured to or operable to support switching, during the at least one clustered signaling period, to an active state from an inactive state, determining the at least one PO within the at least one clustered signaling period, and monitoring the at least one PO for the at least one paging message, where the at least one paging message is received based on the monitoring. By switching to the active state during the at least one clustered signaling period and monitoring the at least one PO, the UE 600 may reduce power consumption by remaining in the inactive state during clustered signaling periods that do not include paging messages for the UE 600, while ensuring reliable reception of paging messages. Additionally, or alternatively, the UE 600 may be configured to or operable to support determining a paging start time based on a start of the SSB and the paging offset, where the paging start time corresponds to the at least one PO. By determining the paging start time based on the start of the SSB and the paging offset, the UE 600 may accurately identify when to monitor for paging messages within the clustered signaling period, reducing unnecessary power consumption from monitoring incorrect time periods.

Additionally, or alternatively, the UE 600 may be configured to or operable to support applying a hash function to an identifier associated with the UE, where the hash function maps the identifier to at least one of a time domain index or a frequency domain index associated with the at least one PO. By applying the hash function to map the identifier to the time domain index or the frequency domain index, the UE 600 may efficiently locate the PO allocated for the UE 600 within the clustered signaling period. Additionally, or alternatively, the UE 600 may be configured to or operable to support the relationship indicates that the paging cycle is one of equal to the periodicity, a multiple of the periodicity, or a fraction of the periodicity. By supporting the relationship that indicates the paging cycle is equal to, a multiple of, or a fraction of the periodicity, the UE 600 may provide for flexible alignment between the paging cycle and the clustered signaling periods to accommodate various deployment scenarios. Additionally, or alternatively, the UE 600 may be configured to or operable to support the set of clustered signaling periods includes additional signaling that is common to a set of UEs including the UE, and where the additional signaling includes at least one of synchronization signals, broadcast control channels, system information, or random access channels. By supporting the set of clustered signaling periods that include additional signaling common to the set of UEs, the UE 600 may provide for efficient resource utilization by consolidating multiple types of signaling within the clustered signaling periods.

Additionally, or alternatively, the UE 600 may support at least one memory (e.g., the memory 604) and at least one processor (e.g., the processor 602) coupled with the at least one memory and configured to cause the UE to receive signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, determine, based on the periodicity and the relationship between the periodicity and the paging cycle, the at least one clustered signaling period, and receive, based on the paging offset relative to the SSB, the at least one paging message during at least one PO within the at least one clustered signaling period.

Additionally, to determine the at least one clustered signaling period, the UE 600 may be configured to or operable to support any one or combination of to determine a current cluster index based on a system frame number and the periodicity, and determine at least one cluster index associated with the at least one clustered signaling period based on the current cluster index and the relationship between the periodicity and the paging cycle. Additionally, or alternatively, the UE 600 may be configured to or operable to support to determine a current cluster index based on a system frame number and the periodicity, and determine, based on a hash function and the relationship between the periodicity and the paging cycle, a hashed identifier associated with the UE, where the current cluster index is associated with the at least one clustered signaling period based on the current cluster index matching the hashed identifier. Additionally, or alternatively, the UE 600 may be configured to or operable to support to switch, during the at least one clustered signaling period, to an active state from an inactive state, determine the at least one PO within the at least one clustered signaling period, and monitor the at least one PO for the at least one paging message, where the at least one paging message is received based on the monitoring.

Additionally, or alternatively, the UE 600 may be configured to or operable to support to determine a paging start time based on a start of the SSB and the paging offset, where the paging start time corresponds to the at least one PO. Additionally, or alternatively, to determine the at least one PO, the UE 600 may be configured to or operable to support to apply a hash function to an identifier associated with the UE, where the hash function maps the identifier to at least one of a time domain index or a frequency domain index associated with the at least one PO. Additionally, or alternatively, the UE 600 may be configured to or operable to support the relationship indicates that the paging cycle is one of equal to the periodicity, a multiple of the periodicity, or a fraction of the periodicity. Additionally, or alternatively, the UE 600 may be configured to or operable to support the set of clustered signaling periods includes additional signaling that is common to a set of UEs including the UE, and where the additional signaling includes at least one of synchronization signals, broadcast control channels, system information, or random access channels.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

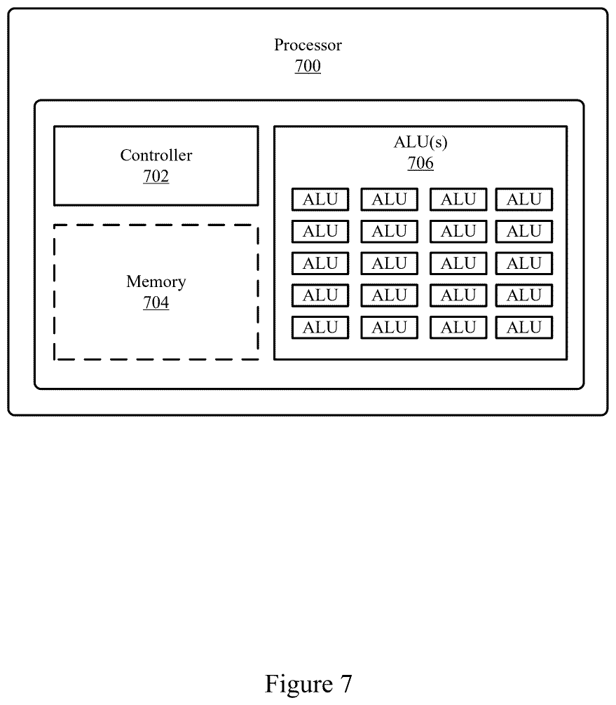

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, determine, based on the periodicity and the relationship between the periodicity and the paging cycle, the at least one clustered signaling period, and receive, based on the paging offset relative to the SSB, the at least one paging message during at least one PO within the at least one clustered signaling period. By receiving signaling that indicates the periodicity, the relationship between the periodicity and the paging cycle, and the paging offset relative to the SSB, the processor 700 may accurately determine when to monitor for paging messages within clustered signaling periods, thereby improving resource utilization and reducing power consumption by enabling the processor 700 to remain in an inactive state during clustered signaling periods that do not include paging messages.

Additionally, the processor 700 may be configured to or operable to support any one or combination of to determine a current cluster index based on a system frame number and the periodicity, and determine at least one cluster index associated with the at least one clustered signaling period based on the current cluster index and the relationship between the periodicity and the paging cycle. By determining the current cluster index and the at least one cluster index associated with the at least one clustered signaling period, the processor 700 may efficiently identify which clustered signaling periods include paging messages intended for the UE, enabling targeted monitoring and reduced power consumption. Additionally, or alternatively, the processor 700 may be configured to or operable to support to determine a current cluster index based on a system frame number and the periodicity, and determine, based on a hash function and the relationship between the periodicity and the paging cycle, a hashed identifier associated with the UE, where the current cluster index is associated with the at least one clustered signaling period based on the current cluster index matching the hashed identifier. By using a hash function to determine the hashed identifier, the processor 700 may distribute POs across multiple clustered signaling periods, reducing congestion and improving paging reliability.

Additionally, or alternatively, the processor 700 may be configured to or operable to support to switch, during the at least one clustered signaling period, to an active state from an inactive state, determine the at least one PO within the at least one clustered signaling period, and monitor the at least one PO for the at least one paging message, where the at least one paging message is received based on the monitoring. By switching to an active state only during the at least one clustered signaling period and monitoring the at least one PO, the processor 700 may conserve power by remaining in the inactive state during periods when paging messages are not expected. Additionally, or alternatively, the processor 700 may be configured to or operable to support to determine a paging start time based on a start of the SSB and the paging offset, where the paging start time corresponds to the at least one PO. By determining the paging start time based on the start of the SSB and the paging offset, the processor 700 may accurately identify when to begin monitoring for paging messages, ensuring reliable reception and avoiding unnecessary monitoring of incorrect time periods.

Additionally, or alternatively, the processor 700 may be configured to or operable to support to apply a hash function to an identifier associated with the UE, where the hash function maps the identifier to at least one of a time domain index or a frequency domain index associated with the at least one PO. By applying the hash function to map the identifier to a time domain index or a frequency domain index, the processor 700 may efficiently locate the specific PO within the clustered signaling period, reducing monitoring overhead and improving paging efficiency. Additionally, or alternatively, the processor 700 may be configured to or operable to support the relationship indicates that the paging cycle is one of equal to the periodicity, a multiple of the periodicity, or a fraction of the periodicity. By supporting flexible relationships between the paging cycle and the periodicity, the processor 700 may accommodate various deployment scenarios and paging requirements, enabling efficient resource utilization across different network configurations. Additionally, or alternatively, the processor 700 may be configured to or operable to support the set of clustered signaling periods includes additional signaling that is common to a set of UEs including the UE, and where the additional signaling includes at least one of synchronization signals, broadcast control channels, system information, or random access channels. By including additional signaling common to a set of UEs within the clustered signaling periods, the processor 700 may leverage the clustered signaling framework to receive multiple types of signaling during a single active period, further reducing power consumption and improving overall system efficiency.

The processor 700 may be configured to or operable to support at least one controller (e.g., the controller 702) coupled with at least one memory (e.g., the memory 704) and configured to cause the processor to transmit signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, and transmit, based on the paging offset relative to the SSB, the at least one paging message during at least one PO within the at least one clustered signaling period of the set of clustered signaling periods. By transmitting signaling that indicates the periodicity, the relationship between the periodicity and the paging cycle, and the paging offset relative to the SSB, the processor 700 may enable UEs to accurately determine when to monitor for paging messages, thereby improving paging reliability and reducing unnecessary power consumption at the UEs.

Additionally, the processor 700 may be configured to or operable to support any one or combination of to determine a current cluster index based on a system frame number and the periodicity, and determine at least one cluster index associated with the at least one clustered signaling period based on the current cluster index and the relationship between the periodicity and the paging cycle. By determining the current cluster index and the at least one cluster index associated with the at least one clustered signaling period, the processor 700 may efficiently schedule paging message transmissions within the clustered signaling periods, ensuring alignment with UE monitoring behavior and improving paging success rates. Additionally, or alternatively, the processor 700 may be configured to or operable to support to determine a current cluster index based on a system frame number and the periodicity, and determine, based on a hash function and the relationship between the periodicity and the paging cycle, respective hashed identifiers associated with a set of UEs, where the current cluster index is associated with the at least one clustered signaling period based on the current cluster index matching at least one hashed identifier of the respective hashed identifiers. By using a hash function to determine respective hashed identifiers for a set of UEs, the processor 700 may distribute paging load across multiple clustered signaling periods, reducing congestion and improving overall network efficiency.

Additionally, or alternatively, the processor 700 may be configured to or operable to support to switch, during the at least one clustered signaling period, to an active state from an inactive state. By switching to an active state only during the at least one clustered signaling period, the processor 700 may conserve power at the NE by remaining in the inactive state during periods when paging transmissions are not scheduled, enabling energy-efficient network operation. Additionally, or alternatively, the processor 700 may be configured to or operable to support the relationship indicates that the paging cycle is one of equal to the periodicity, a multiple of the periodicity, or a fraction of the periodicity. By supporting flexible relationships between the paging cycle and the periodicity, the processor 700 may accommodate various deployment scenarios and paging requirements, enabling efficient resource utilization and scalable network configurations. Additionally, or alternatively, the processor 700 may be configured to or operable to support the set of clustered signaling periods includes additional signaling that is common to a set of UEs, and where the additional signaling includes at least one of synchronization signals, broadcast control channels, system information, or random access channels. By including additional signaling common to a set of UEs within the clustered signaling periods, the processor 700 may consolidate multiple types of signaling transmissions into bursts, improving spectral efficiency and enabling coordinated power management across the network.

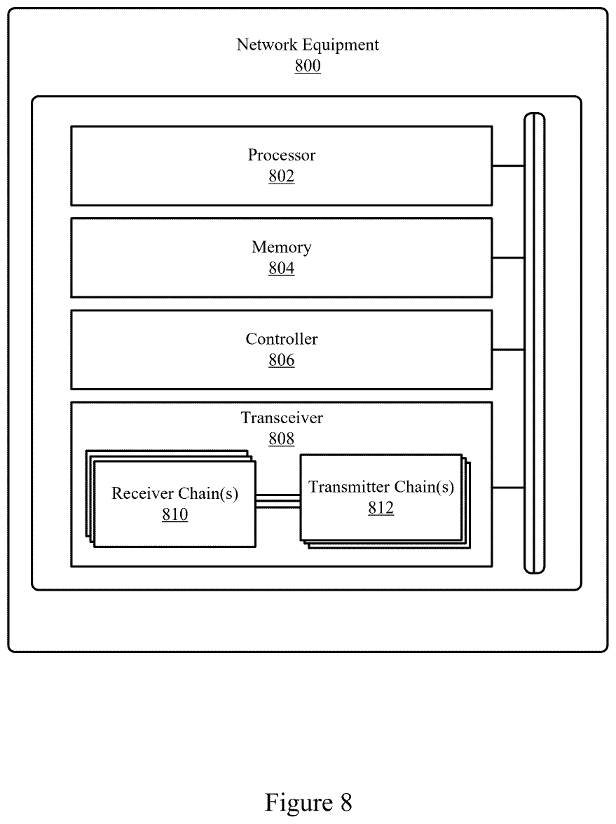

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, and transmitting, based on the paging offset relative to the SSB, the at least one paging message during at least one PO within the at least one clustered signaling period of the set of clustered signaling periods. By transmitting signaling that indicates the periodicity, the relationship between the periodicity and the paging cycle, and the paging offset relative to the SSB, the NE 800 may enable UEs to accurately determine when to monitor for paging messages, thereby improving paging reliability and reducing unnecessary power consumption at the UEs.

Additionally, the NE 800 may be configured to or operable to support any one or combination of determining a current cluster index based on a system frame number and the periodicity, and determining at least one cluster index associated with the at least one clustered signaling period based on the current cluster index and the relationship between the periodicity and the paging cycle. By determining the current cluster index and the at least one cluster index associated with the at least one clustered signaling period, the NE 800 may efficiently schedule paging message transmissions within the appropriate clustered signaling periods, ensuring alignment with UE monitoring behavior and improving paging success rates. Additionally, or alternatively, the NE 800 may be configured to or operable to support determining a current cluster index based on a system frame number and the periodicity, and determining, based on a hash function and the relationship between the periodicity and the paging cycle, respective hashed identifiers associated with a set of UEs, where the current cluster index is associated with the at least one clustered signaling period based on the current cluster index matching at least one hashed identifier of the respective hashed identifiers. By using a hash function to determine respective hashed identifiers for a set of UEs, the NE 800 may distribute paging load across multiple clustered signaling periods, reducing congestion and improving overall network efficiency, while enabling scalable paging management for large numbers of UEs.

Additionally, or alternatively, the NE 800 may be configured to or operable to support switching, during the at least one clustered signaling period, to an active state from an inactive state. By switching to an active state only during the at least one clustered signaling period, the NE 800 may conserve power by remaining in the inactive state during periods when paging transmissions are not scheduled, enabling energy-efficient network operation and reducing operational costs associated with continuous active-state operation. Additionally, or alternatively, the NE 800 may be configured to or operable to support the relationship indicates that the paging cycle is one of equal to the periodicity, a multiple of the periodicity, or a fraction of the periodicity. By supporting flexible relationships between the paging cycle and the periodicity, the NE 800 may accommodate various deployment scenarios and paging requirements, enabling efficient resource utilization, scalable network configurations, and adaptable paging frameworks that can be tailored to different network conditions and UE populations. Additionally, or alternatively, the NE 800 may be configured to or operable to support the set of clustered signaling periods includes additional signaling that is common to a set of UEs, and where the additional signaling includes at least one of synchronization signals, broadcast control channels, system information, or random access channels. By including additional signaling common to a set of UEs within the clustered signaling periods, the NE 800 may consolidate multiple types of signaling transmissions into bursts, improving spectral efficiency, enabling coordinated power management across the network, and reducing signaling overhead by leveraging shared transmission opportunities for multiple signaling types.

Additionally, or alternatively, the NE 800 may support at least one memory (e.g., the memory 804) and at least one processor (e.g., the processor 802) coupled with the at least one memory and configured to cause the NE to transmit signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods, and transmit, based on the paging offset relative to the SSB, the at least one paging message during at least one PO within the at least one clustered signaling period of the set of clustered signaling periods.

Additionally, the NE 800 may be configured to support any one or combination of to determine a current cluster index based on a system frame number and the periodicity, and determine at least one cluster index associated with the at least one clustered signaling period based on the current cluster index and the relationship between the periodicity and the paging cycle. Additionally, or alternatively, the NE 800 may be configured to or operable to support to determine a current cluster index based on a system frame number and the periodicity, and determine, based on a hash function and the relationship between the periodicity and the paging cycle, respective hashed identifiers associated with a set of UEs, where the current cluster index is associated with the at least one clustered signaling period based on the current cluster index matching at least one hashed identifier of the respective hashed identifiers. Additionally, or alternatively, the NE 800 may be configured to or operable to support to switch, during the at least one clustered signaling period, to an active state from an inactive state. Additionally, or alternatively, the NE 800 may be configured to or operable to support the relationship indicates that the paging cycle is one of equal to the periodicity, a multiple of the periodicity, or a fraction of the periodicity. Additionally, or alternatively, the NE 800 may be configured to or operable to support the set of clustered signaling periods includes additional signaling that is common to a set of UEs, and where the additional signaling includes at least one of synchronization signals, broadcast control channels, system information, or random access channels.

The controller 806 may manage input and output signals for the NE 800. The controller 806 may also manage peripherals not integrated into the NE 800. In some implementations, the controller 806 may utilize an operating system such as iOS®, Android®, Windows®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., an LNA) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

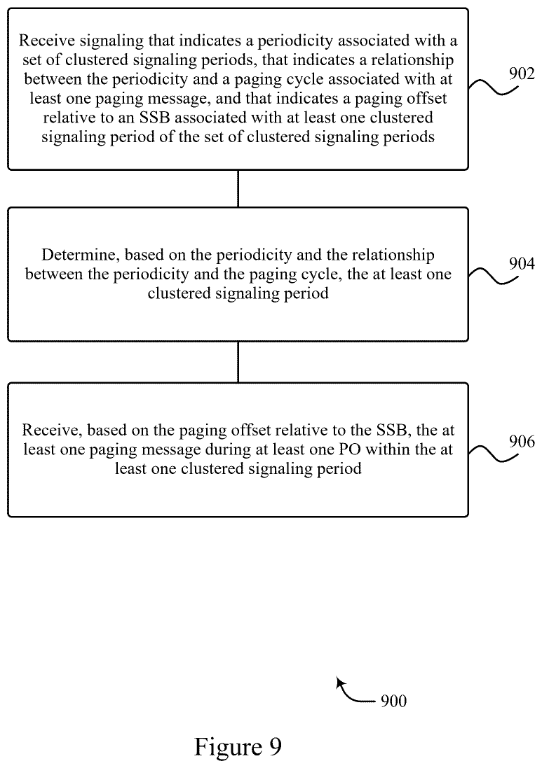

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods. The operations of 902 may be performed in accordance with examples as described herein. In some implementations, aspects of the operations of 902 may be performed by a UE as described with reference to FIG. 6.

At 904, the method may include determining, based on the periodicity and the relationship between the periodicity and the paging cycle, the at least one clustered signaling period. The operations of 904 may be performed in accordance with examples as described herein. In some implementations, aspects of the operations of 904 may be performed by a UE as described with reference to FIG. 6.

At 906, the method may include receiving, based on the paging offset relative to the SSB, the at least one paging message during at least one PO within the at least one clustered signaling period. The operations of 906 may be performed in accordance with examples as described herein. In some implementations, aspects of the operations of 906 may be performed by a UE as described with reference to FIG. 6.

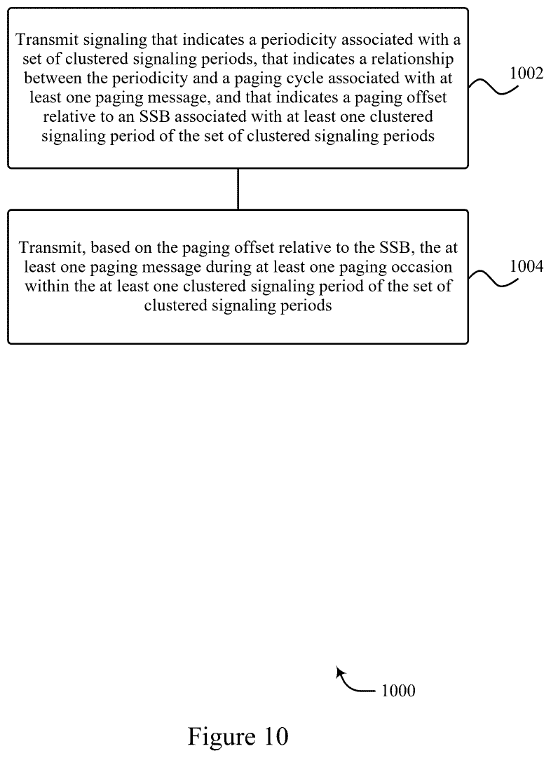

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting signaling that indicates a periodicity associated with a set of clustered signaling periods, that indicates a relationship between the periodicity and a paging cycle associated with at least one paging message, and that indicates a paging offset relative to an SSB associated with at least one clustered signaling period of the set of clustered signaling periods. The operations of 1002 may be performed in accordance with examples as described herein. In some implementations, aspects of the operations of 1002 may be performed by an NE as described with reference to FIG. 8.

At 1004, the method may include transmitting, based on the paging offset relative to the SSB, the at least one paging message during at least one PO within the at least one clustered signaling period of the set of clustered signaling periods. The operations of 1004 may be performed in accordance with examples as described herein. In some implementations, aspects of the operations of 1004 may be performed by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a periodicity associated with a plurality of clustered signaling periods, that indicates a relationship between the periodicity and a paging cycle associated with at least one paging message, and that indicates a paging offset relative to a synchronization signal block (SSB) associated with at least one clustered signaling period of the plurality of clustered signaling periods;
determine, based at least in part on the periodicity and the relationship between the periodicity and the paging cycle, the at least one clustered signaling period; and
receive, based at least in part on the paging offset relative to the SSB, the at least one paging message during at least one paging occasion within the at least one clustered signaling period.

2. The UE of claim 1, wherein to determine the at least one clustered signaling period, the at least one processor is operable to cause the UE to:
determine a current cluster index based at least in part on a system frame number and the periodicity; and
determine at least one cluster index associated with the at least one clustered signaling period based at least in part on the current cluster index and the relationship between the periodicity and the paging cycle.

3. The UE of claim 1, wherein to determine the at least one clustered signaling period, the at least one processor is operable to cause the UE to:
determine a current cluster index based at least in part on a system frame number and the periodicity; and
determine, based at least in part on a hash function and the relationship between the periodicity and the paging cycle, a hashed identifier associated with the UE, wherein the current cluster index is associated with the at least one clustered signaling period based at least in part on the current cluster index matching the hashed identifier.

4. The UE of claim 1, wherein the at least one processor is further operable to cause the UE to:
switch, during the at least one clustered signaling period, to an active state from an inactive state;
determine the at least one paging occasion within the at least one clustered signaling period; and
monitor the at least one paging occasion for the at least one paging message, wherein the at least one paging message is received based at least in part on the monitoring.

5. The UE of claim 4, wherein the at least one processor is operable to cause the UE to determine a paging start time based at least in part on a start of the SSB and the paging offset, wherein the paging start time corresponds to the at least one paging occasion.

6. The UE of claim 4, wherein to determine the at least one paging occasion, the at least one processor is operable to cause the UE to apply a hash function to an identifier associated with the UE, wherein the hash function maps the identifier to at least one of a time domain index or a frequency domain index associated with the at least one paging occasion.

7. The UE of claim 1, wherein the relationship indicates that the paging cycle is one of equal to the periodicity, a multiple of the periodicity, or a fraction of the periodicity.

8. The UE of claim 1, wherein the plurality of clustered signaling periods comprises additional signaling that is common to a plurality of UEs comprising the UE, and wherein the additional signaling comprises at least one of synchronization signals, broadcast control channels, system information, or random access channels.

9. A method performed by a user equipment (UE), the method comprising:
receiving signaling that indicates a periodicity associated with a plurality of clustered signaling periods, that indicates a relationship between the periodicity and a paging cycle associated with at least one paging message, and that indicates a paging offset relative to a synchronization signal block (SSB) associated with at least one clustered signaling period of the plurality of clustered signaling periods;
determining, based at least in part on the periodicity and the relationship between the periodicity and the paging cycle, the at least one clustered signaling period; and
receiving, based at least in part on the paging offset relative to the SSB, the at least one paging message during at least one paging occasion within the at least one clustered signaling period.

10. The method of claim 9, wherein determining the at least one clustered signaling period comprises:
determining a current cluster index based at least in part on a system frame number and the periodicity; and
determining at least one cluster index associated with the at least one clustered signaling period based at least in part on the current cluster index and the relationship between the periodicity and the paging cycle.

11. The method of claim 9, wherein determining the at least one clustered signaling period comprises:
determining a current cluster index based at least in part on a system frame number and the periodicity; and
determining, based at least in part on a hash function and the relationship between the periodicity and the paging cycle, a hashed identifier associated with the UE, wherein the current cluster index is associated with the at least one clustered signaling period based at least in part on the current cluster index matching the hashed identifier.

12. A network equipment (NE) for wireless communication, comprising:
at least one memory; and
at least one processor coupled with the at least one memory and operable to cause the NE to:
transmit signaling that indicates a periodicity associated with a plurality of clustered signaling periods, that indicates a relationship between the periodicity and a paging cycle associated with at least one paging message, and that indicates a paging offset relative to a synchronization signal block (SSB) associated with at least one clustered signaling period of the plurality of clustered signaling periods; and
transmit, based at least in part on the paging offset relative to the SSB, the at least one paging message during at least one paging occasion within the at least one clustered signaling period of the plurality of clustered signaling periods.

13. The NE of claim 12, wherein to transmit the at least one paging message, the at least one processor is operable to cause the NE to:
determine a current cluster index based at least in part on a system frame number and the periodicity; and
determine at least one cluster index associated with the at least one clustered signaling period based at least in part on the current cluster index and the relationship between the periodicity and the paging cycle.

14. The NE of claim 12, wherein to transmit the at least one paging message, the at least one processor is operable to cause the NE to:
determine a current cluster index based at least in part on a system frame number and the periodicity; and
determine, based at least in part on a hash function and the relationship between the periodicity and the paging cycle, respective hashed identifiers associated with a plurality of user equipment (UEs), wherein the current cluster index is associated with the at least one clustered signaling period based at least in part on the current cluster index matching at least one hashed identifier of the respective hashed identifiers.

15. The NE of claim 12, wherein to transmit the at least one paging message, the at least one processor is operable to cause the NE to switch, during the at least one clustered signaling period, to an active state from an inactive state.

16. The NE of claim 12, wherein the relationship indicates that the paging cycle is one of equal to the periodicity, a multiple of the periodicity, or a fraction of the periodicity.

17. The NE of claim 12, wherein the plurality of clustered signaling periods comprises additional signaling that is common to a plurality of user equipment (UEs), and wherein the additional signaling comprises at least one of synchronization signals, broadcast control channels, system information, or random access channels.

18. A method performed by a network equipment (NE), the method comprising:
transmitting signaling that indicates a periodicity associated with a plurality of clustered signaling periods, that indicates a relationship between the periodicity and a paging cycle associated with at least one paging message, and that indicates a paging offset relative to a synchronization signal block (SSB) associated with at least one clustered signaling period of the plurality of clustered signaling periods; and
transmitting, based at least in part on the paging offset relative to the SSB, the at least one paging message during at least one paging occasion within the at least one clustered signaling period of the plurality of clustered signaling periods.

19. The method of claim 18, wherein transmitting the at least one paging message comprises:
determining a current cluster index based at least in part on a system frame number and the periodicity; and
determining at least one cluster index associated with the at least one clustered signaling period based at least in part on the current cluster index and the relationship between the periodicity and the paging cycle.

20. The method of claim 18, wherein transmitting the at least one paging message comprises:
determining a current cluster index based at least in part on a system frame number and the periodicity; and
determining, based at least in part on a hash function and the relationship between the periodicity and the paging cycle, respective hashed identifiers associated with a plurality of user equipment (UEs), wherein the current cluster index is associated with the at least one clustered signaling period based at least in part on the current cluster index matching at least one hashed identifier of the respective hashed identifiers.
